(19) United States
(12) Patent Application Publication
(10) Pub. No.: US 2005/0138172 A1
(43) Pub. Date: Jun. 23, 2005

(54) Use of access points for autonomic determination of available resources

(75) Inventors: Daryl Carvis Cromer, Apex, NC (US); Brandon Jon Ellison, Raleigh, NC (US); Eric Richard Kern, Durham, NC (US); Howard Jeffrey Locker, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/744,474

(22) Filed: Dec. 23, 2003

(51) Int. Cl. G06F 15/173

(52) U.S. Cl. 709/225

(57) ABSTRACT

A wireless LAN system is provided at its access points with structured data indicating resources, connected and independent (e.g. vending machine) in the connect range of the respective access point. Guest clients, upon connecting, may download “greeting” logic to receive and display the structured data to allow the guest to be quickly at home and productive in an unfamiliar setting.

### BACKGROUND OF THE INVENTION

1. Technical Field

The present invention relates generally to wireless communication devices and in particular to wireless communication devices utilized in computer systems. More particularly, the present invention is directed to improving performance and convenience for guests making wireless connection at access points.

2. Description of the Related Art

The need for personal wireless communications is expanding rapidly with the advances in digital communications and personal communications systems. The progress in wireless radio technology and the growth rate of the wireless telephone systems over the last several years is indicative of tremendous market demand for location independent communication via wireless access. Many of the current wireless networks architectures are primarily designed and optimized for voice communications and wide area coverage. With the proliferation of personal and portable computers, and local area networks, it is envisioned that data services and applications such as file server access, client-server execution, and electronic mail will require wireless access to the LAN environment supporting distributed computing. The use of wireless communication systems to transmit data traffic utilizing mobile devices which communicate with a hardwired network, such as a LAN has become widespread. In the future mobile workers, will be connected everywhere on campus with increased productivity. Retail stores and warehouses, for example, may use wireless communications systems with mobile data terminals to track inventory and replenish stock. The transportation industry may use such systems at large outdoor storage facilities to keep an accurate account of incoming and outgoing shipments. In manufacturing facilities, such systems are useful for tracking parts, completed products and defects.

A typical wireless communications system includes a number of fixed access points (also known as base stations) interconnected by a cable medium often referred to as a system backbone In some cases there may be available multiple backbones with respective sets of access points. Associated with each access point is a geographic cell. The cell is a geographic area in which an access point has sufficient signal strength to transmit data and receive data from a mobile device such as a data terminal or telephone with an acceptable error rate. Typically, access points will be positioned along the backbones such that the combined cell area coverage from each access point provides full coverage of a building or site.

Recently a standard for wireless local area networks (WLANs) known as the IEEE 802.11 standard has been adopted and has gained acceptance. The IEEE 802.11 standard for WLANs is a standard for systems that operate in the 2,400-2,483.5 MHz industrial, scientific and medical (ISM) band. The ISM band is available worldwide and allows unlicensed operation of spread spectrum systems. The IEEE 802.11 RF transmissions use multiple signaling schemes (modulations) at different datarates to deliver a single data packet between wireless systems.

In the case of WLAN, frequently there are significant overlaps in cells to increase data capacity. So a user typically has access to several different access points in any given location. The reason for this is that the capacity of the network is a function on number of access points. For 802.11b, an access point provides 11 Mbps, which is shared by number of users.

Mobile computers with WLAN are designed to be carried throughout the system from cell to cell. Each mobile device is capable of communicating with the system backbone via wireless communication between the mobile device and an access point to which the mobile device is registered. As the mobile device roams from one cell to another, the mobile device will typically deregister with the access point of the previous cell and register with the access point associated with the new cell.

Another recently adopted short-range standard has evolved known as the Bluetooth standard (see www.bluetooth.com). The Bluetooth standard is a low-cost short range wireless connection which uses much of the same range of frequencies for its frequency-hopping spread spectrum transmissions as the IEEE 802.11 standard. Bluetooth is a considered a personal area network (PAN) since it is limited to short range distance 30 ft.

A client device with wireless capability provides the user with connection flexibility and convenience. No longer need the user search for a hard wired connection point. Sales offices, college libraries, internet coffee shops may all provide a guest with an access point. A problem with all this connection capability is that the guest user is often connecting to a previously unknown access point. Even access points used previously may be used infrequently and be unfamiliar.

### SUMMARY OF THE INVENTION

It is recognized according to the invention that a newcomer or guest may conveniently connect to an access point using the various wireless technologies discussed above, but the guest may be seriously hampered working in unfamiliar territory. The present invention addresses this problem by so providing the access points with stored resource data and means to access such data, that the guest is enabled to be educated of resources and services available, respective of the location of the access point and its connection range. By so enabling the guest to access location pertinent guidance of the resources (including services) available, the guest is prepared to become quickly productive in the new environment. Indeed, an awareness unexpected resources or services may take the user to a new level of use.

Considering the connection range, choices of printers and scanners and other devices may be identified and their locations specified. Vending machine, telephone locations or emergency exits may be presented; again, considering the connecting range of the access point as a geographic reference. Where multiple access points are available, backbone alternatives may be present and the connection choice may involve resource alternatives. For example, where a campus has separate engineering and arts department backbones, there may be different libraries and printers available according to the access point selected.

The above as well as additional features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use and advantages thereof, will best be understood by reference to the following detailed description of an illustrative embodiment when read in conjunction with the accompanying drawings, wherein:

FIG. 1 shows a Wireless Local Area Network (WLAN) consisting of a plurality of access points, services and peripheral devices suitable for use with a presently preferred embodiment of the present invention;

FIG. 2 shows an access point of FIG. 1 suitable for use in accordance with a presently preferred embodiment of the present invention.

FIG. 3 shows the client device of FIG. 1, suitable for use in accordance with a presently preferred embodiment of the present invention;

FIG. 4 illustrates an access point having a stored data table that contains pertinent information concerning available resources and services in accordance with a presently preferred embodiment of the present invention;

FIG. 5 shows a data table of a type for use in storing resource and service information at an access point, according to a presently preferred implementation for the invention;

FIG. 6 shows a flow diagram illustrating logic and a method for network delivery of data such as the table of FIG. 5 to an access point, in accordance with a presently preferred embodiment of the present invention;

FIG. 7 shows a flow diagram illustrating logic and a method for a client to collect resource and service data from available from access points according to the presently preferred embodiment for the present invention,

FIG. 8 shows a flow diagram illustrating logic and a method for a client to display resource and service data to a guest user according to a presently preferred embodiment for the invention; and

FIG. 9 shows a flow diagram illustrating logic and a method for a network administrator to update the resource table at an access point.

### DESCRIPTION OF THE PREFERRED EMBODIMENT

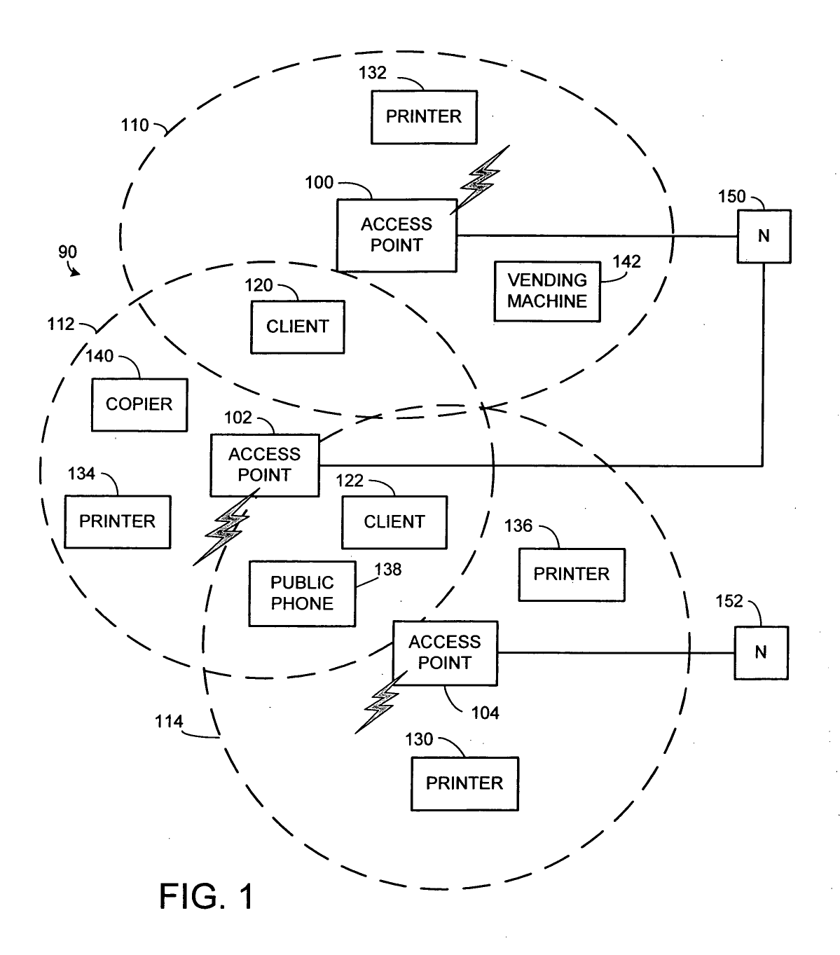

With reference now to the figures, and in particular with reference to FIG. 1, a pictorial representation of a distributed data processing system 100 in which the present invention may be implemented is depicted. Backbone networks having network administrators 150 and 152 (Ethernet, Gigabit Ethernet, etc) are connected to plurality of wireless access points 100, 102 and 104. The connection range of access points 100, 102 and 106 are indicated by dashed lines 110, 112 and 114, respectively. A wireless environment 90 is created from the connectivity of access points 100, 102 and 104, which are assigned to different channels or frequency ranges within ISM (2.4 GHz) band (for the presently preferred implementation for the invention). A client device 120 may connect to access point 100 or access point 102, as it is within the connection ranges 110 and 112. Another client, client device 122, correspondingly may connect to either access point 102 or 104. Furthermore, 802.11 protocol allows for seamless roaming between access points, which would allow client 120 to roam from access point 100 to access point 102, without loss of connection. This would not be the case for client 122 because access point 102 is connected to network host or backbone 150 whereas access point 104 is connected to different host 152.

FIG. 1 also shows printers 130, 132, 134 and 136. The presence and availability of these printers will be made aware to a guest user, according to the invention, by special transfer of structured data to the clients 120 hand 122 upon being connected. Other services such as copier 140, public phone 138 and vending machine 142, though not connected as a part of the network may be included in the structured data as resources for a guest in the geographic connection range.

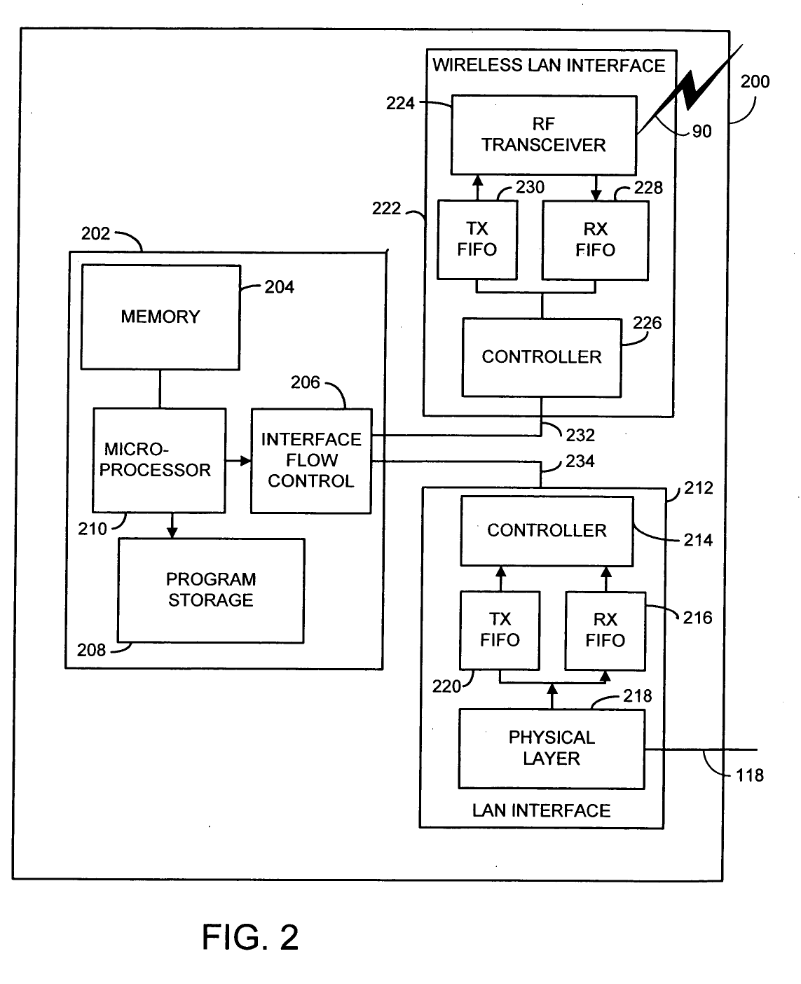

FIG. 2 illustrates the major functional blocks of access points 100,102 and 104. Exemplary access point 200, consists three major components: master bus controller 202, wireless LAN interface 222, and wired LAN interface 212. Bus controller 202 is connected to a wireless interface 222 and a wired interface 212 by connection buses 232 and 234 respectively. Wireless LAN interface 222 which creates the wireless network, consists of a controller 226 which is connected to a TX FIFO 230 and a RX FIFO 228. The FIFOs are connected to RF transceiver 224 which is connected to antenna 90, which generates signals extending over its connection range (see 110,112 and 114 of FIG. 1). Controller 226 is also connected to interface flow control 206 in master bus controller 202. interface flow control 206 controls transfer of data between wireless interface 222 and wired interface 212. Master bus controller 202 consists of microprocessor 210, which pulls executable code from program store 208 and uses memory 204 to hold data during transfers.

Access point 200 also contains LAN interface 212, which is connected the backbone network 118 and consists of physical layer 218, which is connected to TX FIFO, and RX FIFO 220 and 216 respectively. The FIFOs 216 and 220 are to the or media access controller 214, which connects to controller 202 via interface flow control 206 by bus 234.

In a preferred embodiment, the wireless network operates in compliance with the IEEE 802.11 Standard and 802.11b sub-standard, which provides a wireless connectivity system with access to one or more frequency bands for local area communications. The system may conform to the IEEE standard 802.11 “Direct Sequence Spread Spectrum Physical Layer Specification”. Alternatively, the system may be employed utilizing the IEEE standard 802.11 “Frequency Hopping Spread Spectrum Physical Layer Specification” or any other protocol transmitting portions of packets at varying modulations and data rates. The standard defines three physical methods as well as two types of networking. The three different physical layer methods include two using radio frequency and one using infrared. The two radio physical layers operate in 2.4 GHz frequency range, one using frequency hopping spread spectrum (FHSS) and the other using direct sequence spread spectrum (DSSS). The one infrared physical layer operates using baseband infrared. Over the air data rates of 1 Mbps, 2 Mbps, 5.5 Mbps, and 11 Mbps are defined in the standard. The IEEE 802.11 standard defines two types of networking, one being ad hoc networking and the other being infrastructure. An ad hoc network is a network composed solely of stations within mutual communication range of each other via the wireless medium. With ad hoc networking, the wireless clients communicate to each other without the need for a wired network or access points. An infrastructure contains one or more access points which provide wireless clients with access to the wired network. The preferred embodiment deals with physical using radio frequency spectrum and infrastructure network configuration.

The 802.11 standard is limited in scope to the physical (PHY) and medium-access-control (MAC) network layers. The PHY layer corresponds directly to the lowest layer defined by the International Standards Organization in its 7-layer Open System Interconnect (OSI) network model. The MAC layer corresponds to the lower half of the second layer of that same model with Logical Link Control (LLC) functions making up the upper half of OSI layer 2. The standard actually specifies a choice of three different PHY layers, any of which can underlie a single MAC layer. Specifically, the standard provides for an optical-based PHY that uses infrared light to transmit data, and two RF-based PHYs that leverage different types of spread-spectrum radio communications. The RF-based PHYs, meanwhile, can be used to cover significant areas and indeed entire campuses when deployed in cellular-like configurations.

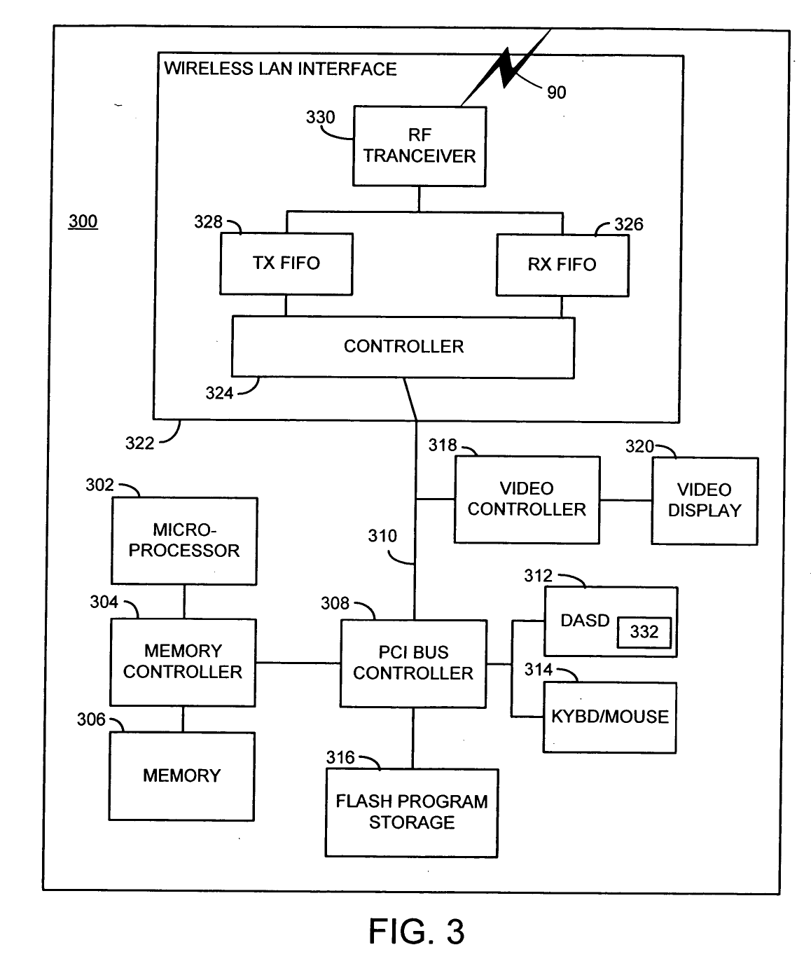

FIG. 3 illustrates an exemplary client computer configured for wireless communication. Computer 300 comprises, but is not limited to, a processing unit 302, which is connected by local bus to memory controller 304. Memory controller 304 is also connected to system memory 306, and a PCI bus controller 308. The system bus 310 may be any of several types of bus structures including a memory bus, a peripheral bus, and a local bus using any of a variety of bus architectures, but is illustrated as PCI bus. By way of example, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus.

The system Flash program storage is nonvolatile memory such as read only memory (ROM) which contains basic input/output system (BIOS), containing the basic routines that help to transfer information between elements within computer 300, such as during boot-up. RAM 306 typically contains data and/or program modules that are immediately accessible to and/or presently being operated on by processing unit 302. By way of example, and not limitation, the program modules include operating system (OS), application programs, other program modules, and program data.

The computer 300 may also include other removable/non-removable, volatile/nonvolatile computer storage media. By way of example only, illustrates a hard disk drive 313 and an optical disk drive 332 that reads from or writes to a removable, nonvolatile optical disk such as a CD ROM or other optical media.

A user may enter commands and information into the computer 300 through input devices such as a keyboard 314 and an integrated pointing device (e.g., a track point or track pad), commonly referred to as a touch pad. These and other input devices are integrated into chassis and are often connected to the processing unit 302 through controllers 304 and 308. A LCD panel 320 (integrated into lid) is also connected to the system bus 310 via an interface, such as a video interface 318.

The computer 300 may operate in a networked environment using logical connections to one or more remote computers, such as a remote computer. The remote computer may be another personal computer, a server, a router, a network PC, a peer device or other common network node, and typically includes many or all of the elements described above relative to the computer 300. When used in a WLAN networking environment, the computer 300 is connected to the WLAN 90 through a WLAN network interface or wireless adapter 322. WLAN adapter 322 connects to system bus 310. Computer 300 may also be connected via wired LAN and/or the Internet via other connection modules such as a modem.

Wireless LAN adapter 322 which connects to wireless network 90, consists of microcontroller 324 which is connected to TX FIFO 328 and RX FIFO 326. The FIFOs are connected to RF transceiver 330 which is connected to an antenna, which generates and receives signals (WLAN 90) to connect at an access point such as access points 100, 102 and 104 (see FIG. 1). Controller 324 is also connected to PCI bus 310.

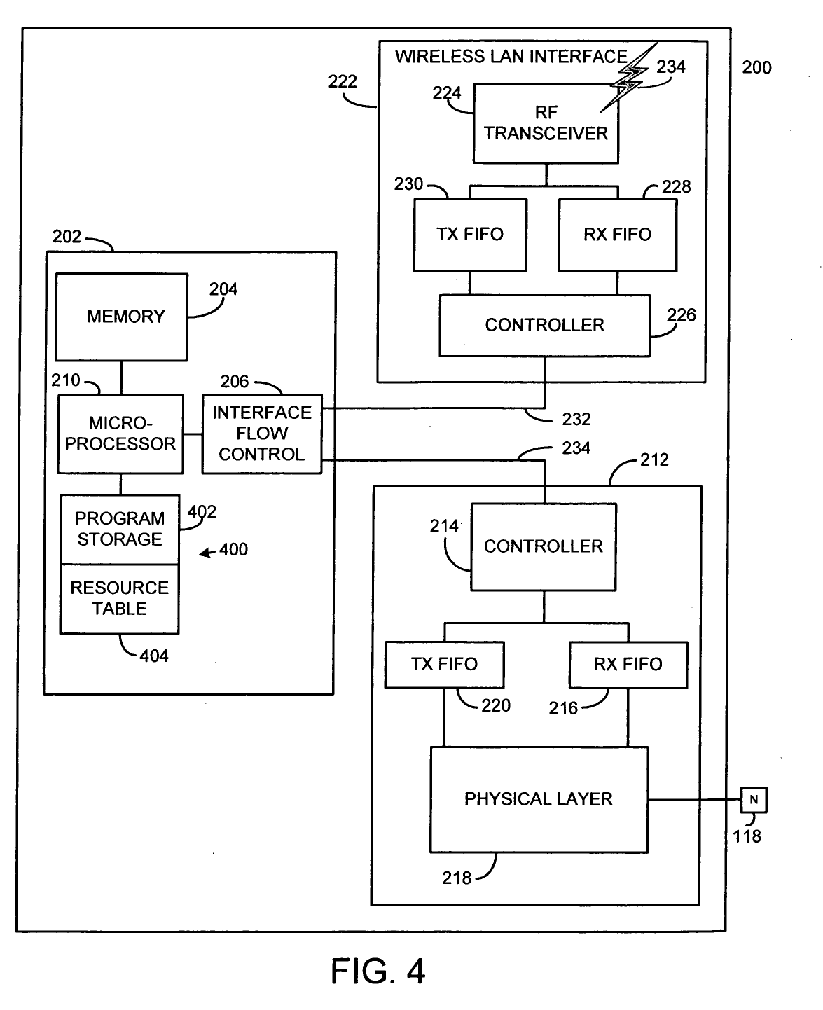

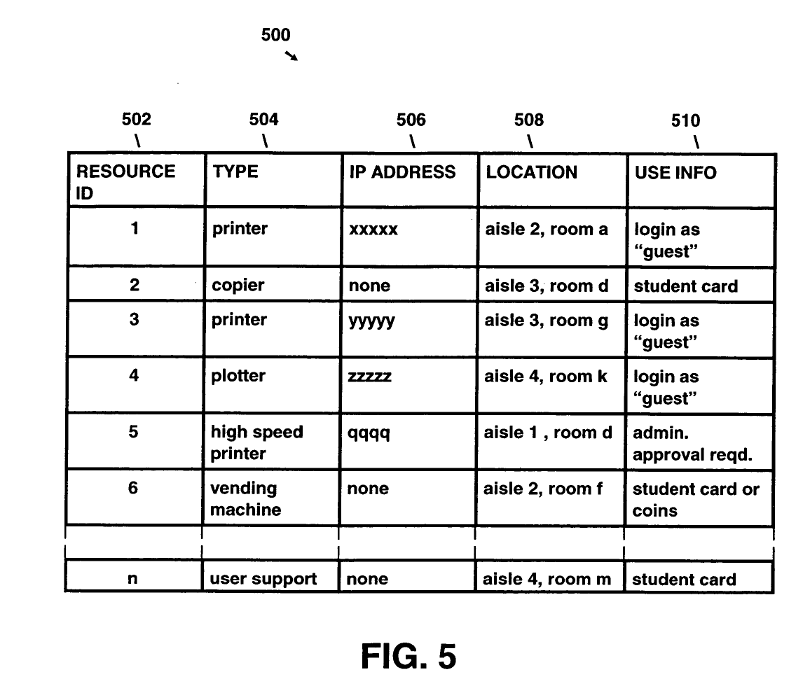

FIG. 4 illustrates a structured data table 404 stored in storage 400 of access point 200(see also discussion of FIG. 2) along with program storage 402. Table 404 is dynamically updated by a program running in the network as described below with respect to FIG. 9. The data of table 404 is discussed in more detail with respect to FIG. 5

FIG. 5 shows a structured data table 500 according to a presently preferred implementation for the invention. As indicated by the table of FIG. 5, each resource has a series of attributes specified which characterize the resource for a guest user and provide characteristics needed to support use. It is presently preferred that the attributes include an ID 502, a type (e.g. printer) 504, an IP address 506 that identifies the resource connection to the network (if any), physical location identifier 508 and any information 510 required for resource use. Other resources and resource information helpful to a guest user may be suggested to those skilled in the art. Nearby emergency exits, for example, may be important resources to a guest unfamiliar with the facility. According to the invention the connection range of the access point serves to provide a frame of reference for the table selections.

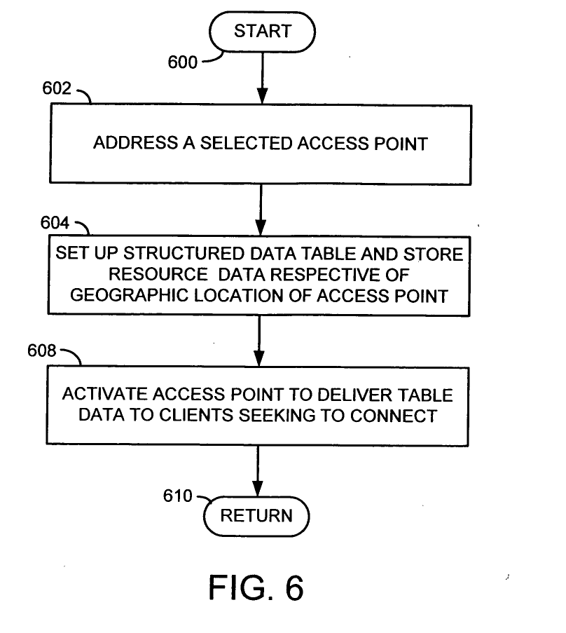

FIG. 6 is a flow chart of logic, preferably programmed logic, used by the network administrator to select clients (602) and direct (604) the appropriate resource data for storage by the access point (FIG. 4, table 404). The logic then activates (608) the access point to handshake with the connecting client to make the information available at the client for display to the user and returns (610). In a preferred implementation the logic checks the current status for the connected resources identified in the data.

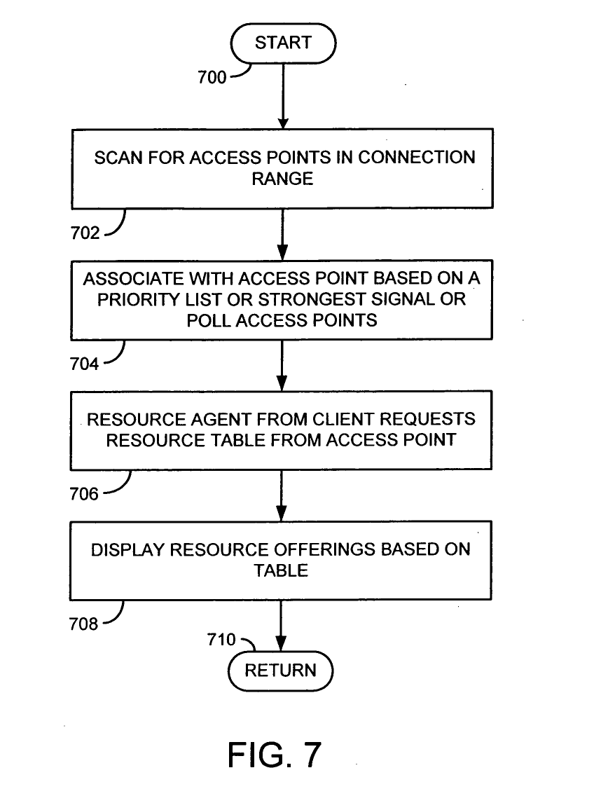

FIG. 7 is logic, preferably program logic, executed by the client 300 (FIG. 3) interacting with access point 200 (FIG. 2) to download a structured resource table. This preferably occurs in the normal process of making the access connection. Once called (700), the client scans (702) for access points 200 in range. A selection (704) is made using a priority, signal strength or polling to compare resources (e.g. if different networks are available as for client 122 of FIG. 1). Resource agent logic collects (706) the data from the access point 200 and stores it in memory 306 (FIG. 3). The data is then displayed (708) or otherwise used to support the guest user and the logic returns (710) for other activity.

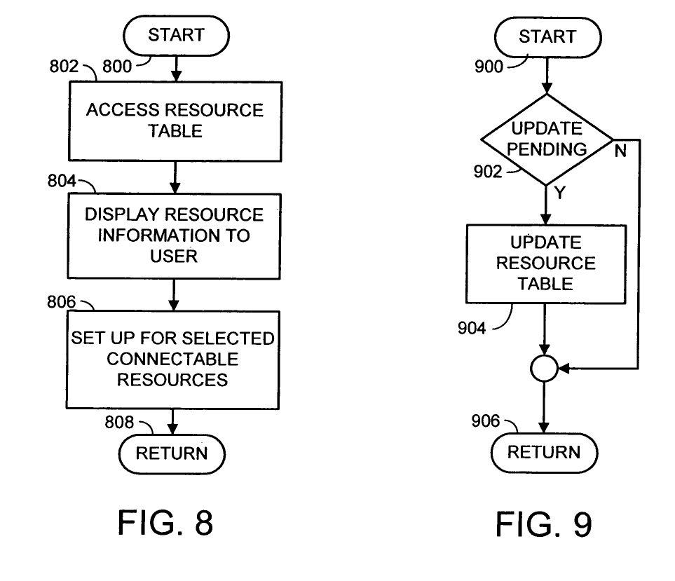

The logic for display (708, FIG. 7) of resource data is shown in further detail in FIG. 8. The logic start (800) is preferably invoked after the selection of and connection to an access point 200. The resource table is accessed (802) from memory 306 and displayed (804) to the guest user. Additionally, resources with IP addresses may be setup (806) for use.

FIG. 9 shows logic for periodic updating of the resource table (404 FIG. 4) by the network 118. Once invoked (900), the logic checks (902) for a pending update and, if present, downloads the new table to resource table storage 404 (FIG. 4) then returns (906).

While the invention has been particularly shown and described with reference to a preferred embodiment, it will be understood by those skilled in the art that various changes in form and detail may be made therein without departing from the spirit and scope of the invention. For example, logic that is preferably implemented as a computer program running on a general purpose computer may be implemented as hard wired logic.

1. A method for providing local resource data to a guest client computer making a wireless connection at an access point, coupled to a network, having a range for client connection, said method comprising:
providing the access point with a structured data indicating resources available in the range of the access point,
storing the structured data at the access point to be available to a connected client,
downloading the structured information to the client, and
displaying the structured information on the client; whereby a guest user at the client may be informed of the resources available through or in the range of the access point.

2. A method according to claim 1 wherein the resources may include unconnected services which are geographically available in the general range of the access point.

3. A method according to claim 1 wherein the structured data is provided to the access point over the network.

4. A method according to claim 1 wherein the structured data is displayed to the client incident to making an access connection.

5. A method according to claim 1 wherein the resource data includes identification of a printer and a vending machine.

6. A method for providing local resource data to a guest client computer making a wireless connection at an access point, coupled to a network, having a range for client connection, said method comprising:
providing the access point, over the network, with a structured data indicating resources available in the range of the access point;
storing the structured data at the access point to be available to a connected client;
downloading, to the client incident to access connection by the client, the structured information; and
displaying the structured information on the client at the time of access connection; whereby a guest user at the client may be informed of the resources available through or in the range of the access point.

7. Apparatus for a LAN system for connecting to clients, which system has a network administrator connected to at least one wireless access point, having a wireless access range for clients in which resources of interest to clients are located, said apparatus comprising:
logic on said network administrator for collecting structured data regarding resources respective of assess range and for directing such data to be stored at a respective access point;
logic at said access point to receive and retain such data and provide it to said client; and
logic at said client to receive and display said data.

8. Apparatus according to claim 7 wherein the data includes information about connected and unconnected resources and the data regarding connected resources includes information regarding IP address and login requirements.

9. Apparatus according to claim 7 wherein the client logic displays the data incident to access connection by the client.

10. Apparatus according to claim 7 wherein there are overlapping access ranges and additional logic associated with the client logic provides for choosing an access point.

11. Apparatus for a LAN system for connecting to clients, that has a network administrator connected to at least one wireless access point, having a wireless access range for clients in which resources of interest to clients are located, said apparatus comprising:
logic on said network administrator for collecting structured data regarding resources respective of assess range and for directing such data to be stored at a respective access point;
logic at said access point to receive and retain such data and provide it to said access point at the time of access connection; and
logic at said client to receive and display said data.

12. Program logic for a LAN system for connecting to clients, that has a network administrator connected to at least one wireless access point, having a wireless access range for clients in which resources of interest to clients are located, said logic comprising:
program logic for running on said network administrator for collecting structured data regarding resources respective of assess range and for directing such data to be stored at a respective access point;
program logic for running on said access point to receive and retain such data and provide it to said client; and
program logic on said client to receive and display said data.

13. Program logic for a LAN system for connecting to clients, that has a network administrator connected to at least one wireless access point, having a wireless access range for clients in which resources of interest to clients are located, said logic comprising:
program logic for running on said network administrator for collecting structured data regarding resources respective of access range and for directing such data to be stored at a respective access point;
program logic for running on said access point to receive and retain such data and provide it to said client at a time of access connection; and
program logic on said client to receive and display said data.

14. Program logic according to claim 13 wherein the client program logic displays the data incident to access connection by the client.

15. Program logic according to claim 14 wherein the client program logic is invoked in succession after client access connection logic.

16. A product comprising:
computer usable media having computer readable code stored therein, the computer readable program code being effective to:
run on a network administrator and collect structured data regarding resources respective of the access range of an access point and direct such data to be stored at a respective access point;
run on said access point to receive and retain such data and provide it to a client at a time of access connection; and
run on said client to receive and display said data.
